(19) United States
(12) Patent Application Publication
(10) Pub. No.: US 2022/0234930 A1
(43) Pub. Date: Jul. 28, 2022

(54) Method for Purifying Contaminated Water

(71) Applicant: MANN+HUMMEL LIFE SCIENCES & ENVIRONMENT HOLDING SINGAPORE PTE. LTD., Singapore (SG)

(72) Inventors: Maximilian WERNER, Darmstadt (DE); Werner RUPPRICHT, Ingelheim am Rhein (DE); Dominik SCHREIER, Mainz (DE); Andreas FISCHER, Aspisheim (DE); Stefan KRAUSE, Darmstadt (DE)

(21) Appl. No.: 17/723,742

(22) Filed: Apr. 19, 2022

Related U.S. Application Data
(63) Continuation of application No. PCT/EP2020/079927, filed on Oct. 23, 2020.

(30) Foreign Application Priority Data
Oct. 23, 2019 (DE) 10 2019 128 677.8

(51) Int. Cl. C02F 9/00; C02F 1/28; C02F 1/44; C02F 1/52; B01D 65/08; B01J 20/28; B01J 20/20

(52) U.S. Cl. CPC C02F 9/00; C02F 1/283; C02F 1/444; C02F 1/5245; C02F 2101/105; B01J 20/28004; B01J 20/28057; B01J 20/20; B01D 2321/185; B01D 65/08

(57) ABSTRACT

In a purification method for purifying contaminated water, the contaminated water contained in a purification tank is filtered by a membrane module disposed in the purification tank. An adsorption agent with powdered activated carbon is added to the purification tank at a raw side of the membrane module. The membrane module is aerated by inflow of air from below. The steps of filtering, adding, and aerating are carried out in parallel and/or sequentially. The purification method is used as a stage of a purification process of a wastewater treatment plant prior to introducing the water purified by the purification method into a river, lake or the ocean.

### CROSS-REFERENCE TO RELATED APPLICATIONS

This application is a continuation application of international application No. PCT/EP2020/079927 having an international filing date of 23 Oct. 2020 and designating the United States, the international application claiming a priority date of 23 Oct. 2019 based on prior filed German patent application No. 10 2019 128 677.8, the entire contents of the aforesaid international application and the aforesaid German patent application being incorporated herein by reference to the fullest extent permitted by the law.

### BACKGROUND OF THE INVENTION

The present invention concerns a method for purifying contaminated water. The method and the device find use in returning contaminated water into the water cycle, for example, as a last stage of a wastewater treatment plant, but also for purifying contaminated precipitation or surface water.

Contaminated water that is to be returned to the water cycle must be purified increasingly more strongly prior to the return. On the one hand, the regulatory requirements on water that is to be returned into rivers, lakes or the ocean increase. On the other hand, the technical requirements increase also, for example, due to contaminations such as bacteria, including also multi-resistant germs, increasing problems due to plastic materials, inter alia also microplastics, but also mineral contaminations or trace substances, for example, phosphate, as they can be generated from industrial or agricultural input.

An overview of the prior art is provided in “Einsatz von Membranverfahren zur Wasser-/Abwasserbehandlung Übersicht der Hersteller von Membranmodulen and-anlagen”(translation: “Use of membrane methods for water/wastewater treatment overview of manufacturers of membrane modules and facilities”), Kompetenzzentrum Mikroschadstoffe, NRW, Germany, 2018. Disclosed in this context are the elimination of micro pollutants by means of oxidative, adsorptive, and physical methods. Adsorptive methods can be performed with pulverized activated carbon or granulated activated carbon. When using a membrane bioreactor, the activated carbon can be added e.g. to the aeration tank. The membrane is used for separation of the activated sludge of biologically purified wastewater so that a secondary clarification tank can be dispensed with. Due to the membrane filtration, the activated carbon is retained also.

The abrasive effect of the activated carbon on the employed membranes has been found to be disadvantageous when using activated carbon in the membrane filtration stage. This reduces the service life of the membranes or reduces the available activated carbon capacity.

### SUMMARY OF THE INVENTION

In view of this background, the present invention has the object to provide a method with which contaminants can be economically and technically removed from water.

The purification method for purifying contaminated water comprises in this context the following steps:
an adsorption agent is added into a purification tank with the contaminated water,
a membrane module is disposed in the purification tank through which the contaminated water is filtered, wherein adding the adsorption agent is realized at the raw side of the membrane module,
the membrane module is aerated by inflow of air from below, preferably with air bubbles.

The aeration can serve in this context primarily for cleaning the membrane module for the filter cake removal.

The adsorption agent comprises in this context powdered activated carbon, preferably produced from organic material, preferably wood and/or peat.

The steps can take place in parallel and/or sequentially.

The method can be used as a, preferably last, stage of the purification process of a wastewater treatment plant prior to introducing the purified water into a river, lake or the ocean. Of course, such a method would also be useable for the purification of surface water, precipitation water or other contaminated water.

It has been found surprisingly that powdered activated carbon produced on the basis of wood or peat is acting less abrasively than, for example, activated carbon produced on a mineral basis.

In the purification method, preferably only one membrane module in series in the purification tank is flowed through by the contaminated water, wherein the contaminated water is supplied from a sedimentation tank, without flowing through a second membrane module, to the membrane module and is introduced from the purification tank, without flowing through a further membrane module, into a river, lake, or the ocean. Obviously, a plurality of membrane modules can be disposed in parallel in the purification tank in order to increase the flow rate.

The nominal grain size of the powdered activated carbon is preferably between 10 and 150 μm, further preferred between 1 and 50 μm. In this range, the activated carbon in the purification tank can be held suspended by means of the blown-in air, a sufficient purification can be obtained, and the abrasive effect on the membrane will not become too large yet in this context.

Preferably, in the purification method the iodine number of the employed powdered activated carbon is greater than 900 mg/g, further preferred greater than 1,000 mg/g.

The inner surface area of the powdered activated carbon is preferably larger than 800 m²/g according to the BET method.

Prior to adding, the adsorption agent can be mixed, suspended or dissolved in water, wherein in this context different components of the adsorption agent can be present in suspended, mixed or dissolved form. In this way, a more precise adding is possible because adjustment of the concentration of the activated carbon takes place in a separate device outside of the purification tank independent of the purification tank.

Adding the adsorption agent can be carried out in the purification tank at the membrane bioreactor without an upstream contact zone.

In the purification method, precipitation and/or flocculation agents can be furthermore added. They can be used, for example, for reduction of the phosphorus contents. In particular, iron or aluminum solids, in particular FeCl₃ or FeAlCl₃ are added in this context.

A microfiltration stage, preferably however an ultrafiltration stage, is used as membrane filtration.

The membrane module can be embodied as a flat membrane module or pocket module but also as a hollow fiber membrane module.

A concrete tank but also optionally a modified standard container can serve as purification tank.

### BRIEF DESCRIPTION OF THE DRAWINGS

FIG. 1 shows a schematic of a device for the purification method.

FIG. 2 shows the determination of the optimal suspended solids content.

### DESCRIPTION OF PREFERRED EMBODIMENTS

For illustration of the invention, the method will be explained with the aid of an embodiment.

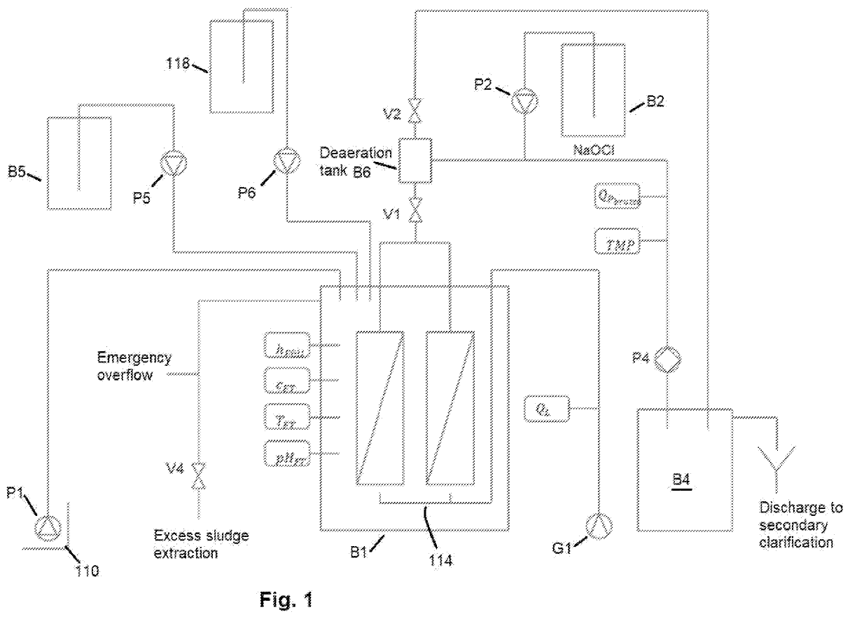

The purification method is employed for processing biologically treated water that is still contaminated with various substances. A schematic of a device for performing the method is illustrated in FIG. 1. The embodiment concerns water that has been purified by means of a conventional wastewater treatment plant. In this context, an ultrafiltration membrane technology with powdered activated carbon addition is used as a fourth purification stage after the pre-purification, the biological purification, and the secondary purification. The purification of the contaminated water is carried out with at least one immersed flat membrane module; in another embodiment, it can also be another form of a membrane module, for example, a hollow fiber membrane module. The method can be expanded by adding precipitation and flocculation agents (iron or aluminum salts).

With the ultrafiltration membrane, suspended particles, dirt particles, viruses, bacteria, and inter alia powdered activated carbon are retained. The added powdered activated carbon serves in this context as an adsorption agent for removing contaminants from the contaminated water, for example, micro pollutants, in particular microplastics, dissolved pharmaceutical substances, corrosion protection agents. Due to the addition of precipitation and flocculation agents, dissolved substances such as phosphates are converted into insoluble ones and also separated as solids from the wastewater by the ultrafiltration membrane.

The combination of the method elements ultrafiltration technology with filtration and sedimentation, addition of powdered activated carbon for adsorption, and optionally addition of precipitation and flocculation agents for chemical precipitation constitute the efficient method in this context.

The contaminated water that is to be processed enters the purification tank B1 as feed from the secondary clarification 110. It is conveyed by a feed pump P1 into the purification tank B1 in which immersed flat membrane modules 112 with a membrane of polyether sulfone (PES) or polyvinylidene fluoride (PVDF) with a nominal pore size of 0.01 μm to 0.1 μm are installed.

The purification of the contaminated water is carried out by conveying through the membrane 112 to the so-called permeate side (into permeate tank B4). For this purpose, a vacuum is generated by a pump. The flow performance of the method is net at 4-31 LMH (liter/m²h).

Below the membrane module 112, an aeration device 114 is installed through which air generated by a compressor G1 is distributed. For the operation of the method, specific air volume flows, relating to the surface of rise, of 0.15-0.35 m³/m²*h are used.

The membrane modules 112 are operated in the following filtration cycles: filtration, relaxation, backwashing, relaxation. In the relaxation phase, the membrane unit without filtration operation is flushed with air.

The purification of the membrane unit is realized depending on the degree of soiling, with sodium hypochlorite, hydrogen peroxide, and/or citric acid (schematically shown in store B2 delivered by pump P2). However, other acids, bases or oxidation agents can be used also.

Adding powdered activated carbon with a nominal grain size of 1-50 μm is carried out from a powdered activated carbon store B5 directly into the filter chamber B1. The target concentration of the powdered activated carbon in the filtration tank is between 5-20 mg/l.

The employed powdered activated carbon is produced from wood and/or peat.

The suspended solids contents in the filter container to be adjusted by the addition of powdered activated carbon lies between 2 and 6.5 g/l but it can also be in a range of 1 to 10 g/l. For controlling the total solids in the purification tank, a portion of the activated carbon is discharged discontinuously.

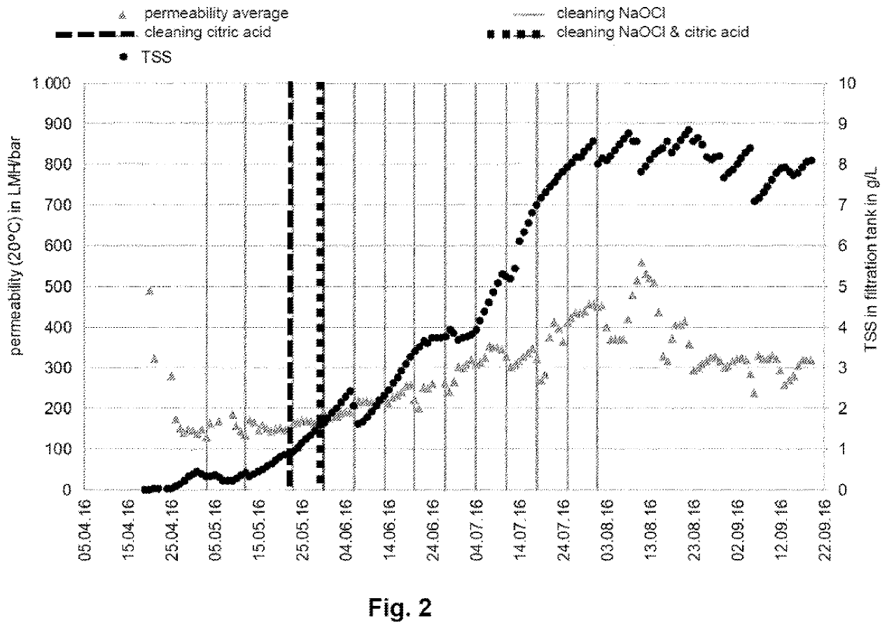

The diagram of FIG. 2 shows the determination of the optimum suspended solids contents depending on the permeability of the membrane unit detected in operation. According to the prior art, the immersed flat membrane is operated as membrane bioreactor (MBR) application with suspended solids contents of 8 to 12 g/l and maximally 15 g/l.

Due to the use as a membrane-based method for processing biologically treated contaminated water and the addition of powdered activated carbon, it was possible to lower the suspended solids content in the filter chamber and to obtain at the same time a higher permeability and process stability.

For mixing in the filter chamber and maintaining a powdered activated carbon suspension, a stirrer can be supplemented in the filter chamber in addition to the aeration.

Adding iron and aluminum salts that are used as precipitation and flocculation agents is realized from a precipitant store 118 directly into the filter chamber B1 by pumps P6. The added quantity depends on the composition of the medium to be processed and the phosphorus content contained therein. Due to the chemical precipitation of dissolved phosphorus (orthophosphate) in a solid insoluble form, this substance can be removed from the medium. Due to the nominal pore width, the ultrafiltration membrane retains particulate solid-bound phosphorus and the chemically precipitated phosphorus. Due to this method component, total phosphorus concentrations in the permeate, the water purified by the ultrafiltration membrane, of less than 0.2 mg/l, preferably less than 0.1 mg/l, are obtained.

Bacteria and germs are also separated from the medium with the method combination, in addition to micro pollutants by the powdered activated carbon addition and phosphorus elimination by the precipitation and flocculation agent addition.

What is claimed is:

1. A purification method for purifying contaminated water, comprising:
filtering contaminated water contained in a purification tank by a membrane module disposed in the purification tank;
adding an adsorption agent comprising powdered activated carbon to the purification tank at a raw side of the membrane module;
aerating the membrane module by inflow of air from below;
carrying out filtering, adding, and aerating in parallel and/or sequentially;
using the purification method as a stage of a purification process of a wastewater treatment plant prior to introducing the water into a river, a lake or the ocean.

2. The purification method according to claim 1, further comprising disposing precisely one membrane module in the purification tank to be flowed through in series by the contaminated water and supplying the contaminated water from a sedimentation tank, without flowing through another membrane module, to said precisely one membrane module and introducing the water purified by the purification method into a river, lake or the ocean from the purification tank, without flowing through a further membrane module.

3. The purification method according to claim 1, further comprising producing the powdered activated carbon from wood and/or peat.

4. The purification method according to claim 1, further comprising selecting a nominal grain size of the powdered activated carbon to be between 1 μm and 150 μm.

5. The purification method according to claim 4, wherein the nominal grain size of the powdered activated carbon is selected to be between 1 μm and 50 μm.

6. The purification method according to claim 1, further comprising selecting an iodine number of the powdered activated carbon to be greater than 900 mg/g.

7. The purification method according to claim 6, wherein the iodine number of the powdered activated carbon is selected to be greater than 1,000 mg/g.

8. The purification method according to claim 1, further comprising selecting an inner surface area of the powdered activated carbon to be greater than 800 m²/g determined according to the BET method.

9. The purification method according to claim 1, further comprising mixing, suspending or dissolving the adsorption agent in water prior to adding the adsorption agent.

10. The purification method according to claim 1, further comprising adding precipitation and/or flocculation agents.

11. The purification method according to claim 10, wherein the precipitation and/or flocculation agents are iron salts or aluminum salts.

12. The purification method according to claim 1, wherein filtering by the membrane module is by microfiltration.

13. The purification method according to claim 1, wherein filtering by the membrane module is by ultrafiltration.

14. The purification method according to claim 1, further comprising selecting the membrane module from the group consisting of a flat membrane module and a hollow fiber membrane module.

15. The purification method according to claim 1, further comprising selecting the purification tank from the group consisting of a concrete tank or a standard container.
